(19) United States
(12) Patent Application Publication
(10) Pub. No.: US 2023/0105070 A1
(43) Pub. Date: Apr. 6, 2023

(54) PROTECTIVE MASK, AIR FILTRATION ELEMENT AND AIR TREATMENT ELEMENT

(71) Applicant: MASTER DYNAMIC LIMITED, Hong Kong (CN)

(72) Inventors: Yau Chuen YIU, Hong Kong (CN); Juan CHENG, Hong Kong (CN); Chak Yeung AU, Hong Kong (CN); Wing Chi TANG, Hong Kong (CN); Ching Tom KONG, Hong Kong (CN)

(73) Assignee: MASTER DYNAMIC LIMITED, Hong Kong (CN)

(21) Appl. No.: 17/799,103

(22) PCT Filed: Feb. 11, 2021
(86) PCT No.: PCT/CN2021/076615

§ 371 Date: Aug. 11, 2022

(30) Foreign Application Priority Data
Feb. 11, 2020 (HK) 32020002570.0
Feb. 25, 2020 (HK) 32020003261.5
Feb. 25, 2020 (HK) 32020003264.9

(51) Int. Cl. B01D 39/16; A41D 13/11; B01D 39/18; A62B 23/02

(52) U.S. Cl. CPC B01D 39/1615; A41D 13/11; B01D 39/1623; B01D 39/18; A62B 23/025; B01D 2239/0442; B01D 2239/0407; B01D 2239/0258; B01D 2239/0618; B01D 2239/0428; B01D 2239/0622; B01D 2239/0631; B01D 2239/0478; B01D 2239/0654

(57) ABSTRACT

A layer for a protective mask (100a, 100b, 200a) comprises at least a first sublayer (122b, 218b), wherein the first sublayer (122b, 218b) includes a first substrate and a layer of a plurality of nanoparticles (124b, 7) of a nanomaterial provided on the first substrate. The protective mask (100a, 100b, 200a) includes an outer layer (120b, 230a) which is made of an organic fibular network bonded with nanomaterials. An air filtration element (900, 1070, 1240) for attenuation of airborne contaminants includes negatively charged nanodiamonds (920, 1320). A filter (1100, 1200, 1500, 1600) for an air conditioning system (1130, 1530) or an air purifier (1230, 1630) comprises the air filtration element (900, 1070, 1240). An air treatment element (1140,1300,1540,1640) comprises nanodiamonds (920,1320) including colour centers. The protective mask (100a, 100b, 200a), the air filtration element (900, 1070, 1240), the air treatment element (1140,1300,1540,1640) and the filter (1100, 1200, 1500, 1600) overcome or at least partially ameliorate some of the deficiencies as associated with those of the prior art.

### TECHNICAL FIELD

The present invention relates to protection against airborne pollutant substances, and more particularly a face mask, air filtration element and an air treatment element for providing protection to a user from airborne pollutant substances.

### BACKGROUND OF THE INVENTION

As is known. airborne contaminants are considered to be present everywhere in the environment.

In hospitals, for example, contaminants may include a variety of airborne respiratory infectious diseases, such as measles and tuberculosis, and new emerging diseases such as severe acute respiratory syndrome (SARS) and other H1N1 diseases such as influenzas, as well as in more recent times 2019-nCoV acute respiratory disease, also known as novel coronavirus pneumonia (NCP), which is an infectious respiratory disease caused by the 2019 novel coronavirus (2019-nCoV), first detected during the 2019-20 Wuhan coronavirus outbreak.

Some other diseases that can be caused by inhalation of bacteria, include pneumonia, Legionnaire's disease, diphtheria, meningitis, whooping cough, Q-fever, and tuberculosis.

The inhalation of virus, can cause the common cold, influenza, measles, mumps, chicken pox, shingles, and also infectious mononucleosis.

In highly polluted areas, an aerosol, which is suspension of solid or liquid particles within a gas, can become a major airborne contaminant.

It is known that absorption of airborne contaminants by people of sufficient concentrations into the body can be potentially very dangerous, and in some cases lethal. It is also known than airborne contaminants can be absorbed into the body of a person through skin, through eyes, or via the respiratory system. Absorption of airborne particles into lungs via the respiratory system, can cause both acute and chronic health problems to a person.

In addition to public areas which are considered of a risk, in confined places such as transport vehicles, the cabin is often re-circulated, and people may be exposed to bacteria or other germs which expelled by another passenger seated even in a distant area of the cabin. For example, a passenger sitting at the rear of the cabin may sneeze, and introduce numerous bacteria and other germs into the environmental air.

In addition to such germs travelling to adjacent passengers, the germs may also be transported by the air recirculation system to other passengers throughout the cabin. As such, germs emanating from a single person anywhere in the aircraft may be transported to expose the rest of the passengers to that person's germs. As is known, the hazard of airborne contaminants may be somewhat reduced through the application of basic controls such as increasing ventilation, or persons with protective equipment such as protective masks.

Protective masks are commonly used by people in hospitals, researchers in laboratories, workers in construction sites, as well as the general public in highly polluted areas or during flu season.

Other manners in which protection of persons against from airborne bacteria and viruses have been attempted is by way of filter elements, such as HEPA (High-efficiency particulate air) filters within air conditioners and air conditioning such as in automobiles and aircraft.

Other manners in which protection of persons against from airborne bacteria and viruses have been attempted is by implementation of air purifier devices which may include a filter for trapping fine airborne particulates, some of which have used HEPA filters.

### Objective of the Invention

It is an objective of the present invention to provide a protective mask, an air filtration element, and an air treatment element, which overcome or at least partially ameliorate some of the deficiencies as associated with those of the prior art.

### SUMMARY OF THE INVENTION

In a first aspect, the present invention provides a layer for a protective mask, said layer comprising at least a first sublayer, wherein first sublayer includes a first substrate and a layer of a plurality of nano particles of a nano material provided on said first substrate.

The first substrate is preferably a non-woven material.

The nano material is preferably nanodiamonds.

The layer may further comprises a second sublayer, wherein said second sublayer includes a second substrate and layer of an antibacterial material provided on said second substrate.

The second substrate is preferably a non-woven material.

The antibacterial material is preferably Chitosan.

The layer further comprises a third sublayer, wherein said third sublayer includes a layer of a metallic nanomaterial and a layer of nanocarbon material.

The metallic nanomaterial is preferably formed from silver nanoparticles.

In a second aspect, the present invention provides protective mask for removing air-borne contaminates from air inhaled by a user, wherein said mask includes a layer according to the first aspect.

The protective mask may comprise an outer layer, and inner layer, and wherein said layer of the second aspect is an intermediate layer disposed between said outer layer and said inner layer.

The outer layer may be formed from a non-woven hydrophobic material, and said inner layer may be formed form a cotton material.

In a third aspect, the preset invention provides a protective mask for degrading germs and suppressing the penetration of germs to the human, wherein the mask includes a multilayer structure consisting an outer layer, a middle layer, and an inner layer, wherein the outer layer is a physical block to reject the water vapor, liquids, and aerosols, and wherein the outer layer is made of an organic fibular network bonded with nanomaterials.

The nanomaterials may be non-zero band gap nanomaterial, or the nanomaterials may be wide band gap nanomaterials.

The outer layer may be exposed to light may emit localized light to irradiate the blocked germs.

The outer layer may be exposed to light may promote electron transfer to degrade the blocked germs.

The outer layer may be hydrophobic due to hydrophobic surface termination of the organic fibular network.

The middle layer may be a physical trap to germs.

The middle layer may be a multilayer stacked organic fibular network.

The multilayer stacked organic fibular network can be made of chitosan and nano-charcoal.

The multilayer stacked organic fibular network can be bound with metallic nanomaterials.

The middle layer may be exposed to light may generate localized light to irradiate the trapped germs.

The outer layer exposed to light may promote electron transfer to degrade the blocked germs.

The intralayer fibular network spacing may be reduced in the direction from the outer layer towards the inner layer in order to trap different size germs.

The inner layer is a hydrophobic for physically rejecting the water vapor, liquids, and aerosols from a user's mouth.

In a fourth aspect, the present invention provides a protective mask wherein the mask includes an inner layer and an outer later, wherein the outer layer is layer according to the first aspect.

The first substrate may be a non-woven material.

The nano material may be nanodiamonds.

Preferably the layer of a plurality of nano particles of a nano material is the outermost layer of the mask and facing away from the inner layer.

In a fifth aspect, the present invention provides an air filtration element for attenuation of airborne contaminants, said element comprising a planar air permeable substrate having a first surface, and a second surface opposed to said first surface; and a plurality of nanodiamonds to bonded to said first surface of said air permeable substrate; wherein said plurality of nanodiamonds includes negatively charged nanodiamonds, and wherein said charged nanodiamonds attenuate airborne contaminants.

The airborne contaminants preferably include bacteria and viruses.

The charged nanodiamonds may be bipolar, and said nanodiamonds may be bonded to said first surface of said air permeable substrate by way of electrostatic charge.

The nanodiamonds may be polar, and wherein said nanodiamonds may be bonded to said first surface of said air permeable substrate by way of a primer system.

The air permeable substrate is preferably formed from a synthetic fabric.

Thee air permeable substrate is preferably formed from a non-woven fabric.

The air permeable substrate is may be formed from a fabric from the group including common non-woven fabrics, melt-blown non-woven fabrics, and electrospun microfibers or nanofibers coated non-woven fabrics.

The air permeable substrate may be formed from a non-woven fabric, wherein the material from which the non-woven fabric is formed from the group including pretreated pure or a mixture of polypropylene, polyethylene, polyethylene terephthalate, polyacrylonitrile, polybutylene terephthalate, polycarbonate, polyester, polyamide, cellulose, and polyvinyl chloride.

The air permeable substrate may be formed from a mixture of natural fabrics and synthetic fabrics coated non-woven fabric.

The plurality of nanodiamonds may be deposited on the air permeable substrate by an ultrasonic spray method, an electrospinning method, or an electrostatic spray method.

The plurality of nanodiamonds may be stable in irregular shape.

The plurality of nanodiamonds may be functionalized with carboxyl or hydroxyl group.

The air filtration element may further comprise a plurality of nanodiamonds bonded to said second surface of said air permeable substrate;

The plurality of nanodiamonds may be in the form of commercially available dispersion in aqueous, partially oxidized nanodiamonds, or annealed air-annealed powders.

The plurality of nanodiamonds may be hydrophilic or dual hydrophobic-hydrophilic depending on the surface functional groups.

In a sixth aspect, the present invention provides a surgical mask which includes an air filtration element according to the fifth aspect.

In a seventh aspect, the present invention provides a filter for an air conditioning system which includes an air filtration element according to the fifth aspect.

In a eighth aspect, the present invention provides a filter for an air purifier which includes an air filtration element according to the fifth aspect.

In a ninth aspect, the present invention provides an air treatment element, said air treatment element comprises a planar air permeable substrate having a first surface, and a second surface opposed to said first surface; a plurality of nanodiamonds bonded to at least said first surface of said air permeable substrate; wherein the nanodiamonds of said plurality of nanodiamonds includes colour centers, such that upon said colour centers being excited by light stimulus, airborne contaminants adjacent approaching said colour centers of the nanodiamonds said airborne contaminants are denaturized.

The airborne contaminants may be denaturized by electrons emitted from the excited colour centers of the nanodiamonds.

The airborne contaminants may be denaturized by nano-light illuminated from the excited colour centers of the nanodiamonds.

The airborne contaminants preferably include bacteria and viruses.

The nanodiamonds may have functional groups on their surface, and wherein the surface functional groups provide for adhesion of said airborne contaminants to said nanodiamonds. The adhesion provides for electron transfer to said airborne contaminants for denaturization thereof.

The adhesion may further provide for nano-light source to said airborne contaminants for denaturization thereof.

The air permeable substrate is preferably formed from a synthetic fabric. The air permeable substrate is preferably formed from a non-woven fabric.

The air permeable substrate may be formed from a fabric from the group including common non-woven fabrics, melt-blown non-woven fabrics, and electrospun microfibers or nanofibers coated non-woven fabrics.

The air permeable substrate may be formed from a non-woven fabric, wherein the material from which the non-woven fabric is formed from the group including pretreated pure or a mixture of polypropylene, polyethylene, polyethylene terephthalate, polyacrylonitrile, polybutylene terephthalate, polycarbonate, polyester, polyamide, cellulose, and polyvinyl chloride.

The air permeable substrate may be formed from a mixture of natural fabrics and synthetic fabrics coated non-woven fabric.

The plurality of nanodiamonds may be deposited on the air permeable substrate by an ultrasonic spray method, an electrospinning method, or an electrostatic spray method.

The plurality of nanodiamonds may be stable in irregular shape.

The plurality of nanodiamonds may be functionalized with carboxyl or hydroxyl group.

The air treatment element may further comprise a plurality of nanodiamonds bonded to said second surface of said air permeable substrate;

The plurality of nanodiamonds may be in the form of commercially available dispersion in aqueous, partially oxidized nanodiamonds, or annealed air-annealed powders.

The plurality of nanodiamonds may be hydrophilic or dual hydrophobic-hydrophilic depending on the surface functional groups.

In a tenth aspect, the present invention provides a surgical mask, wherein said surgical mask includes an air treatment element according to the ninth aspect.

In a eleventh aspect, the present invention provides a filter for an air conditioning system, wherein said filter includes an air treatment element according to the ninth aspect.

In a twelfth aspect, the present invention provides a filter for an air purifier, wherein said filter includes an air treatment element according to the ninth aspect.

Referring to any of the above ninth to twelfth aspects, the light stimulus may be provided by ambient light, said light stimulus may be provided by natural light, said light stimulus may be provided by an artificial light source, wherein said artificial light source is an LED light source, or combinations thereof.

### BRIEF DESCRIPTION OF THE DRAWINGS

In order that a more precise understanding of the above-recited invention can be obtained, a more particular description of the invention briefly described above will be rendered by reference to specific embodiments thereof that are illustrated in the appended drawings.

The drawings presented herein may not be drawn to scale and any reference to dimensions in the drawings or the following description is specific to the embodiments disclosed.

Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1a shows a schematic representation of a protective mask according to the present invention;

FIG. 1b shows a schematic representation of the cross section of an embodiment a protective mask according to the present invention;

FIG. 2a shows a schematic representation of the cross section of a further embodiment a protective mask according to the present invention;

FIG. 2b shows the cross section of the layer of the protective mask according to an embodiment of the present invention;

FIG. 3a illustrates the attachment of the nanoparticles of the first sublayer to the bacteria;

FIG. 3b illustrates the inhibition of metabolic processes of the bacteria by nanoparticles of the first sublayer;

FIG. 4a shows the molecular structure of Chitosan at the second sublayer;

FIG. 4b shows the comparison of number of bacteria per swatch with and without the presence of Chitosan;

FIG. 5a shows a schematic representation of the filtration of airborne virus particles and dust particles by the silver nanoparticles;

FIG. 5b shows the inactivation of the incoming microorganisms or virus by the silver nanoparticles at the third sublayer;

FIG. 6 shows the enlarged view of the first filter layer of the protective mask according to the present invention;

FIG. 7 shows the enlarged view of the second filter layer of the protective mask according to an embodiment of the present invention.

FIG. 8 shows a schematic representation of an example of functionalizing substrate fabrics layer with nanodiamonds via ultrasonic spraying process according to the present invention;

FIG. 9 shows a schematic representation of an air filtration element as provided by the present invention;

FIG. 10 shows a schematic representation of a surgical mask, wherein said surgical mask includes an air filtration element of the present invention and in FIG. 9;

FIG. 11 shows a schematic representation of a filter for an air conditioning system, wherein said filter includes an air treatment element of the present invention and in FIG. 9;

FIG. 12 shows a schematic representation of a filter for an air purifier, wherein said filter includes an air filtration element of the present invention and in FIG. 9;

FIG. 13 shows a schematic representation of an air treatment element according to the present invention;

FIG. 14 shows a schematic representation of a surgical mask, wherein said surgical mask includes an air treatment element according to the present invention and FIG. 13;

FIG. 15 shows a schematic representation of filter for an air conditioning system, wherein said filter includes an air treatment element according to the present invention and FIG. 13; and

FIG. 16 shows a schematic representation of a filter for an air purifier, wherein said filter includes an air treatment element according to the present invention and FIG. 13.

### DETAILED DESCRIPTION OF THE PREFERRED EMBODIMENTS

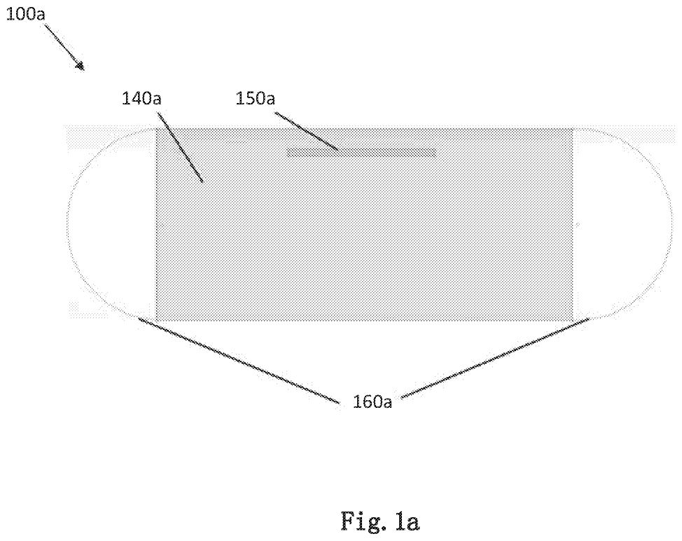

The present invention as referred to in FIGS. 1 to 7 relates to a protective mask for the wearing in the face of a person, in order to protect a person from airborne environmental contaminants, such as bacteria and viruses. Such masks are often called “surgical masks” or “medical masks”.

It is illustrated in FIG. 1a a protective mask 100a to according to the present invention, to protect a user.

The protective mask 100a includes a mask body 140a to be placed on the wearer's face for covering the nose and the mouth. The mask body 140a is kept firmly in place by two ear loops 160a, which are to be hang behind the ears for securing the mask on the face of the wearer.

There are at least two other ways to secure the protective mask 100a. The first way is the tie-on, which consists of four non-woven straps that are tied behind the head. The other one is the headband, an elastic strap which is secured behind the head. As will be understood, any fixation mechanism is appropriate.

As is also shown in FIG. 1a, the protective mask 100a further comprises a nose clip 150a which is located at the upper edge of the protective mask 100a. Such nose clip 150a should be made of a flexible material, preferably a metal strip, to allow the upper edge of the protective mask 100a to be molded to the bridge of the nose of the wearer. This ensures the protective mask 100a fits smugly over the face.

As shown in FIG. 1 b, there is a protective mask 100b according to the present invention. The mask 100b includes an inner layer 110b and an outer 120b.

The outer layer 120b is layer comprising at least a first sublayer 122b.

The first sublayer 122b includes a first substrate and a layer of a plurality of nano particles 124b of a nano material provided on said first substrate 122b.

The protective mask 100b may be be placed on the wearer's face for covering the nose and the mouth. The mask 100b is kept firmly in place by two ear loops 130b, which are to be hang behind the ears for securing the mask on the face of the wearer, for example.

The first substrate 122b may be a non-woven material, and nano material is preferably nanodiamonds.

The layer of a plurality of nano particles 124b of a nano material is the outermost layer 120b of the mask 100b and facing away from the inner layer 110b.

The features and the manner in which the nanoparticles assist in deactivating the incoming microorganisms, such as bacteria or virus, is described in following embodiments and is equally applicable to the present embodiment.

As will be understood by those skilled in the art, a protection mask such as of the present type, can be provided with multiple layers in different arrangements and the layer as presently described as carrying the nanoparticles may be an outer layer, the direction which the layer of nanoparticles faces may be inward or outward.

As such, a protective mask according to the present invention, may protect a user from airborne contaminants, such as virus or bacteria, and/or attenuate or ameliorate a user spreading contaminants, such as virus or bacteria, to other persons.

Thus, protective masks as provided by the present invention may act as a mutually beneficial particle, protecting both the wearer from third parties, as well as protecting third parties from the wearer of the mask.

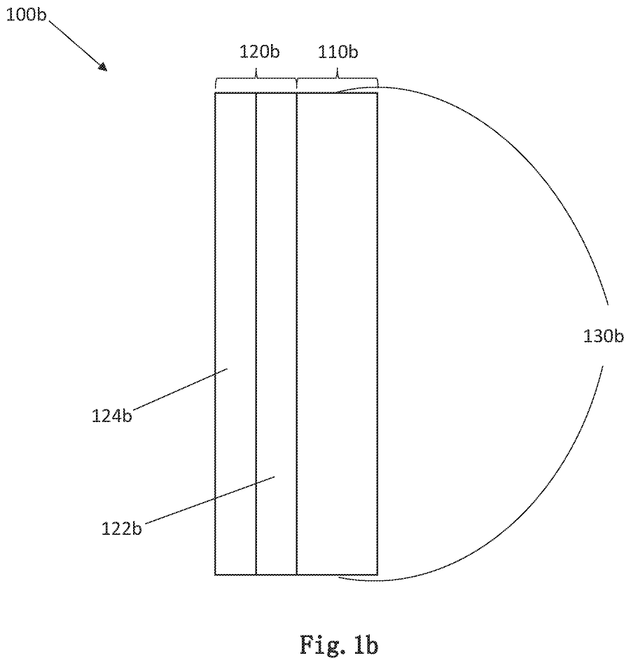

It is shown in FIG. 2a is a further embodiment of a mask 200a according to the present invention. that the mask body 240a of a protective mask 200a may be formed of three layers, including an inner layer 210a, a layer 220a and an outer layer 230a.

The outer layer 230a is a physical block to reject the water vapor, liquids, and aerosols from entering the protective masks. It is preferably made of hydrophobic non-woven fabric in order to prevent moisture getting into other layers of the protective mask 200a. It is also may, in embodiments, arranged such that when the outer layer 230a is exposed to light, localized light will be emitted to irradiate or promote electron transfer to degrade any germs trapped within the outer layer 230a.

The inner layer 210a, on the other hand, is mainly a physical block to reject any water vapor, liquids, or aerosols exiting from the protective mask 200a. The inner layer 210a makes direct contact with the face of the wearer, it therefore should be made of a soft material, preferably cotton, to provide comfort to the wearer.

There is shown in FIG. 2a that a further layer 220a is placed between the inner layer 210a and the outer layer 230a of the protective mask 200a which may be considered as an intermediate layer. The layer 220a acts as a key filtration member within the protective mask 100, to stop smaller particles such as bacteria and virus from entering or exiting the mask. The layer 220a also helps inhibiting the activity of any bacteria or virus which are attached to the outer layer 230a, to provide extra safety to the wearer.

The cross section of such an intermediate layer 220b is illustrated in FIG. 2b. As is shown in FIG. 2b, layer 220b further comprises a first sublayer 218b, wherein the first sublayer includes a first substrate and a layer of plurality of nano particles of a nanomaterial, preferably nanodiamonds, provided on said first substrate.

In an embodiment of the present invention, the layer 220b also comprises a second sublayer 216b and a third sublayer 214b. The first sublayer 218b is arranged to be the outermost sublayer and is in contact with the outer layer 230a of the protective mask 200a. The third sublayer 214b is arranged to be in contact with the inner layer 210b of the mask.

The nanomaterials of the first sublayer 218b such as nanodiamonds which are hydrophobic in nature. This helps preventing moisture of the incoming air to further pass into other layers of the mask.

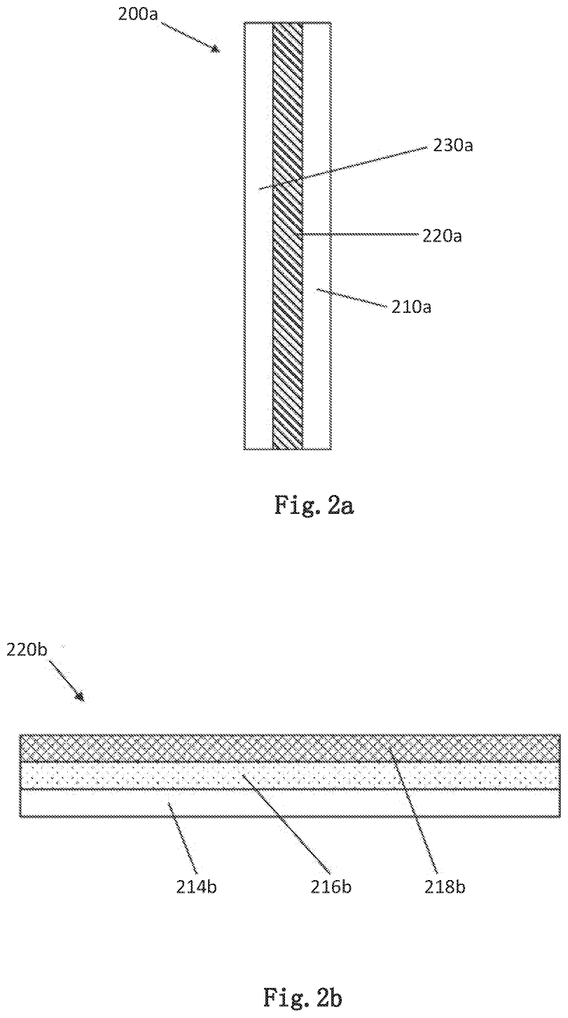

The nanodiamonds of the first sublayer 218b assist in deactivating the incoming microorganisms. To achieve so, the nanodiamonds of the first sublayer 218b attach to the bacterial or virus wall by intermolecular forces, such as charges interaction or hydrogen bonding between the surface groups. The process of which is illustrated by FIG. 3a.

The attaching of nanodiamonds to the walls of the microorganisms can cause an increase in membrane stress of the microorganisms, which leads to physical damage of the membrane and eventually killing the microorganisms.

Nanodiamonds in the first sublayer 218b can also inhibit the metabolic process of the microorganism.

As is shown in FIG. 3b, the microorganisms are unable to produce antioxidants in response to the oxidative stress produced by nanodiamonds, and therefore the metabolism of the microorganisms is inhibited.

Referring to the second sublayer 216b, it includes a second substrate and a layer of an anti-bacterial material provided on the second substrate. The anti-bacterial material is preferably Chitosan.

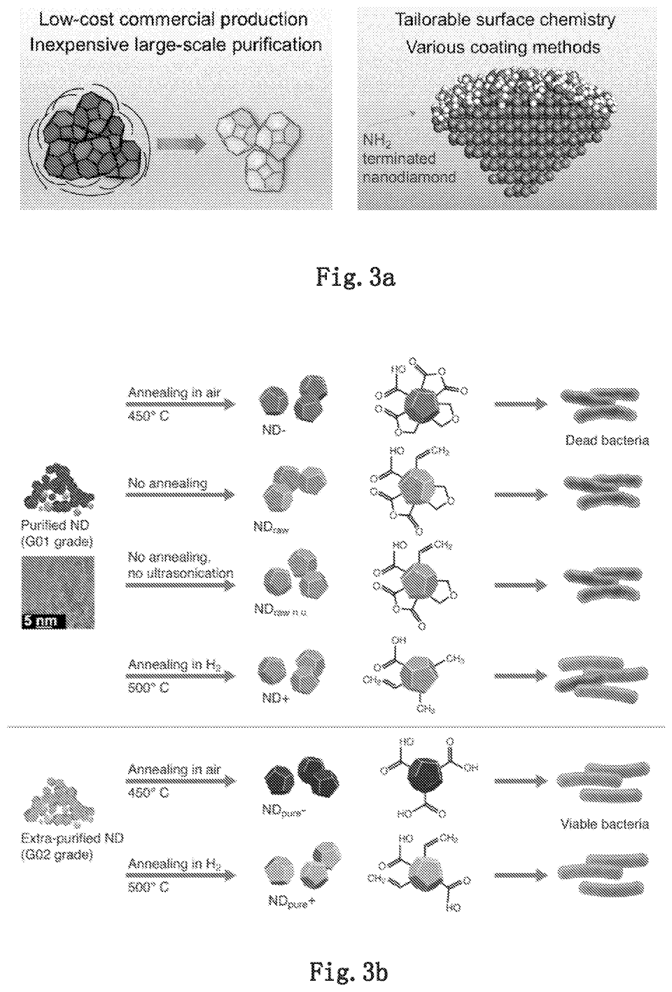

Chitosan is a known anti-bacterial material which is able to inhibit bacteria, fungi and viruses. The molecular structure of Chitosan is shown in FIG. 4a.

The poly-cationic nature of chitosan interferes with the metabolism of microorganisms such as bacteria, fungi and viruses by stacking the cells' surface. Chitosan binds with the DNA of the microorganisms to inhibit mRNA synthesis such that nutrients are blocked from entering the cells of the microorganisms. Without intake of nutrients, activities of the microorganisms can be inhibited which eventually leads to the death of the microorganisms.

FIG. 4b demonstrates the anti-bacterial ability of Chitosan. It can be seen from FIG. 4b that with the presence of Chitosan, the number of bacteria per swatch is much lower than that without Chitosan, since Chitosan prevents bacterial colonization.

The third sublayer 214b includes a third substrate, wherein a layer of a metallic nanomaterial and a layer of nanocarbon material are coated on the substrate. During manufacturing of the third sublayer, a layer of nanocarbon material is to be coated on the third substrate first, and then metallic nanomaterial layer.

Preferably, the layer of metallic nanomaterial is silver nanoparticles, and the layer of nanocarbon material is nano charcoal.

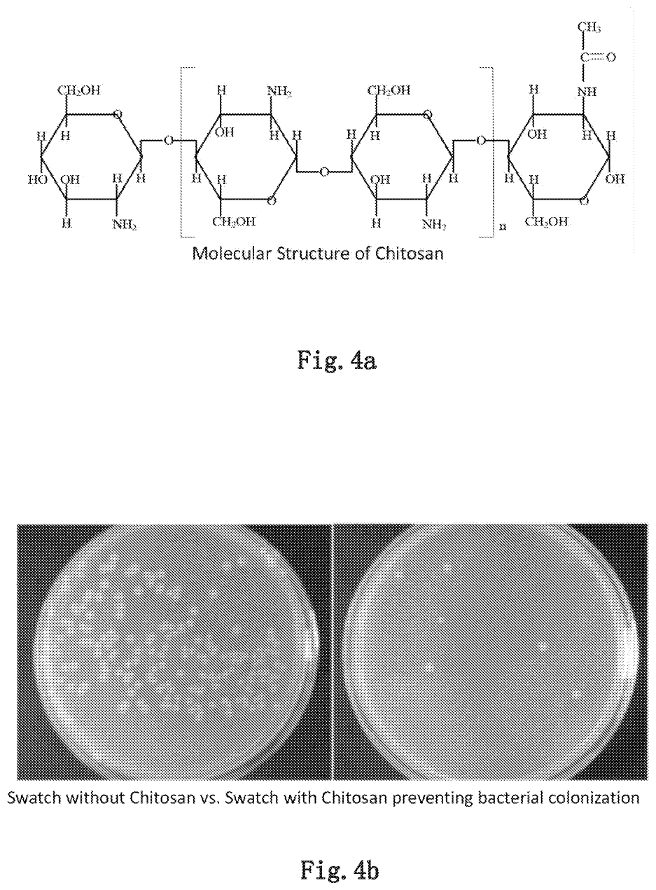

Silver nanoparticles of the third sublayer 214b are able to kill the microorganisms trapped within the sublayer, as is shown in FIG. 5a.

Silver nanoparticles destroy or pass through the cell membranes of the microorganisms, and bond to the —SH group of cellular enzymes, causing microorganism's metabolisms to be altered and their growth to be inhibited, and eventually killing the microorganisms. Such a process is illustrated by FIG. 5b.

Silver nanoparticles can also catalyze the production of oxygen radicals that oxidize the molecular structure of bacteria and viruses. This leads to denaturation of proteins, cell death, metabolite efflux, and interference with DNA replication of the microorganisms.

Nano-charcoal particles, which is also disposed on the third sublayer 214b is an activated nano-carbon source. These nano-charcoal particles are more porous and absorbent than regular charcoal, making it a good filter for filtering incoming small particles.

Nano-charcoal particles can also reduce humidity, deodorize the air, and eliminate static electricity. As the main functional groups of bamboo charcoal are hydrogen bond (CH), double carbon bond (C═C), hydroxyl and oxygen (OH), nano-charcoal particles can also absorb Sulfide, Formaldehyde, Benzene, Phenol or Chloroform and other chemicals.

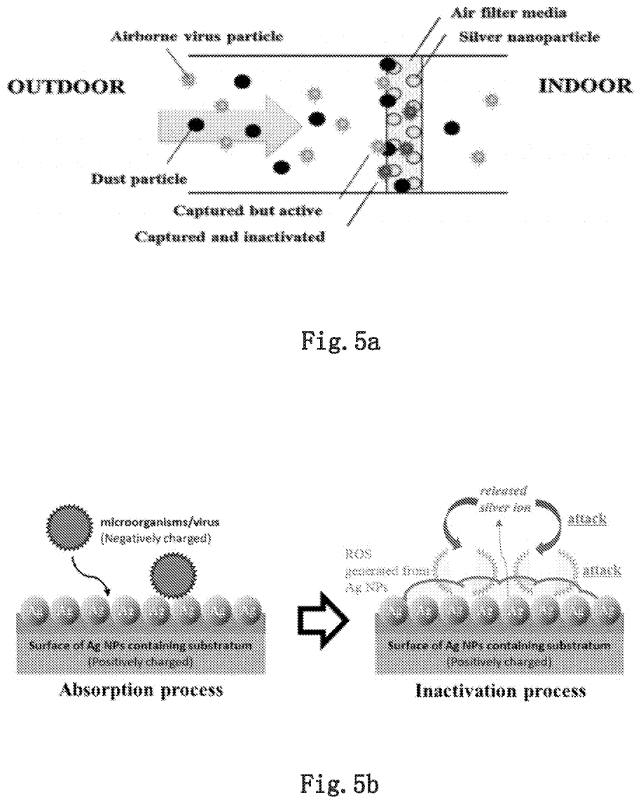

FIG. 6 shows the schematic representations of the first sublayer 218b, wherein a plurality of nano particles 7 of a nanomaterial are disposed within the porous substrate 8.

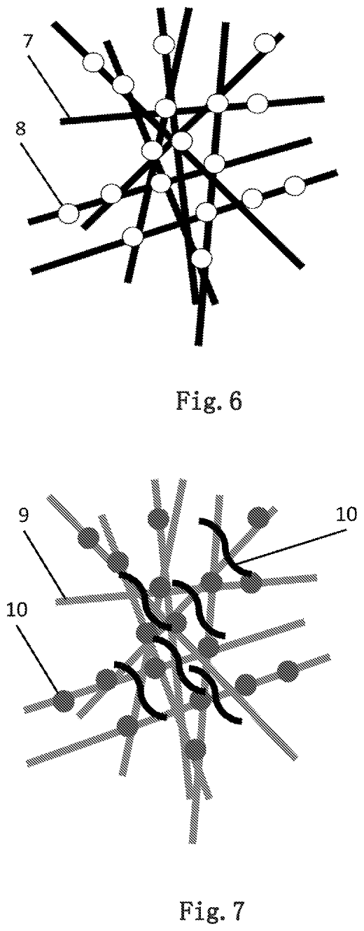

Similarly, FIG. 7 shows the schematic representations of the third sublayer 214b, wherein the nano-charcoal 10 and silver nanoparticles 11 are disposed within the third substrate 9.

It should be noted that such a protective mask according to the present invention, provides protection of a user from the environment, and also protects other people of the user may be ill end expelling bacteria and germs.

Further, the layer 220b as shown in the example of FIG. 2b may be oriented in either direction when in a mask of FIG. 1a and FIG. 2a, with the first sublayer 218b facing either towards or away from a user.

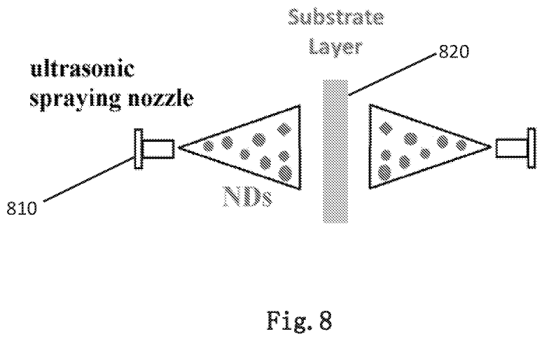

Referring now to FIGS. 8 to 12, the present invention relates to an air filtration element in order to protect a person from airborne environmental contaminants, such as bacteria and viruses.

Embodiments of the invention may be implemented in masks are often called “surgical masks” or “medical masks”.

Other embodiments of the invention may be implemented in filters for air conditioning, air filtering installations, air purifying apparatus and machines, air sterilizers/air sterilisers, germicidal lamps for purifying air.

At present, the three-ply medical and other protective masks, generally used to prevent viral/bacterial spreading and airborne pollutant substances, are made up from a melt-blown material placed between non-woven fabrics. The melt-blown material simply acts as a physical barrier that stops microbes from entering or exiting the mask.

The ability to kill bacteria and/or viruses on the spot is a desirable function for protective masks, as is provided by the present invention.

Nanodiamonds (NDs), as a carbon-based nanomaterials, are characterized by a size of crystal grains less than 100 nm, have found a broad application in medical textile field owing to the unique characteristic, such as high surface area, high adsorption capability, excellent mechanical properties and chemically inert, etc. In addition, when used as nano-sized filler for cotton/polymer matrices, NDs can protect cotton/polymeric matrices from photodegradation due to their ability to attenuate efficiently UV radiation.

The present invention provides a new method to make a functional filtering layer for the protective masks, which can be used in the medical, industrial and environmental fields.

The functionalized filtering layer is a matrix of a cotton or polymer substrate with charged-nanodiamond. The cotton/polymer substrate can be originally surface charged or coated with primer for tightly binding nanodiamonds.

The originally surface charged substrate can be positively charged cotton/synthetic fabrics/non-woven/mixture of above fabrics.

For synthetic fabrics, they can be in the forms of common non-woven fabrics, melt-blown non-woven, and electrospun microfibers or nanofibers coated non-woven fabric.

The raw material of the positively charged substrates can be pretreated pure or a mixture of natural fabrics like cotton, wool & cellulose, and synthetic fabrics like polypropylene, polyethylene, polyethylene terephthalate, polyacrylonitrile, polybutylene terephthalate, polycarbonate, polyester, polyamide, and polyvinyl chloride.

The functionalization procedure is based on ultrasonic spray method as shown in FIG. 8, which briefly demonstrates that the nanodiamonds are sprayed onto from the two sides of the substrate layer during the functionalization procedure.

Alternative functionalized procedure can also be electrospinning method, or electrostatic spray method, for example

The NDs used in the method is a charged irregular particles method. It can be in the form of commercially available dispersion in aqueous, partially oxidized NDs, or annealed air-annealed powders.

The charged NDs can be antibacterial and antimicrobial active. The NDs can be polar or bipolar, and hydrophilic or dual hydrophobic-hydrophilic depending on the surface functional groups. The NDs are adsorbed to the substrate layer due to the mutual electrostatic force and its high surface-to-volume ratio.

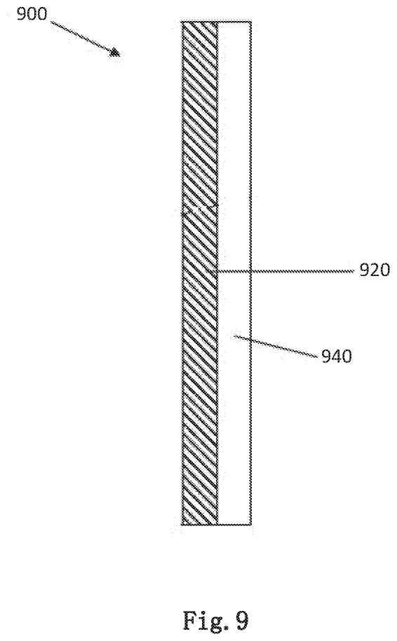

Referring to FIG. 9, there is shown an air filtration element 900 for attenuation of airborne contaminants, said element comprising a planar air permeable substrate having a first surface 910, and a second surface opposed to said first surface. The air filtration element 900 further comprises a plurality of nanodiamonds 920 bonded to said first surface of said air permeable substrate. The plurality of nanodiamonds 920 includes negatively charged nanodiamonds, and wherein said charged nanodiamonds attenuate airborne contaminants.

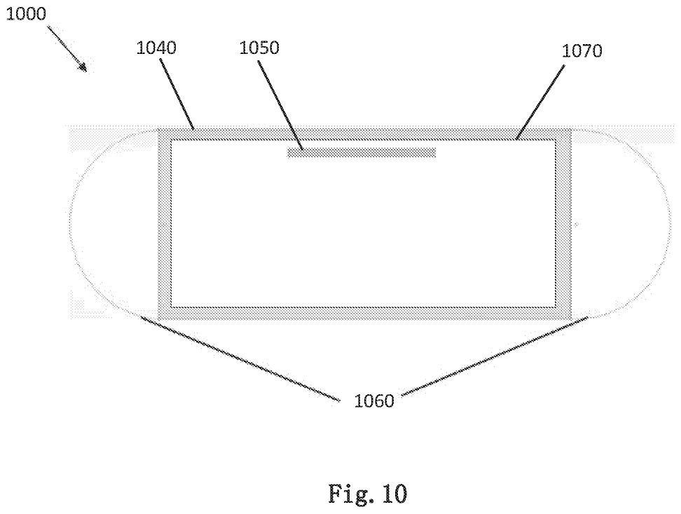

Referring to FIG. 10 there is shown a schematic representation of a surgical mask 1000, wherein said surgical mask includes an air filtration element 1070 of the present invention and in FIG. 9.

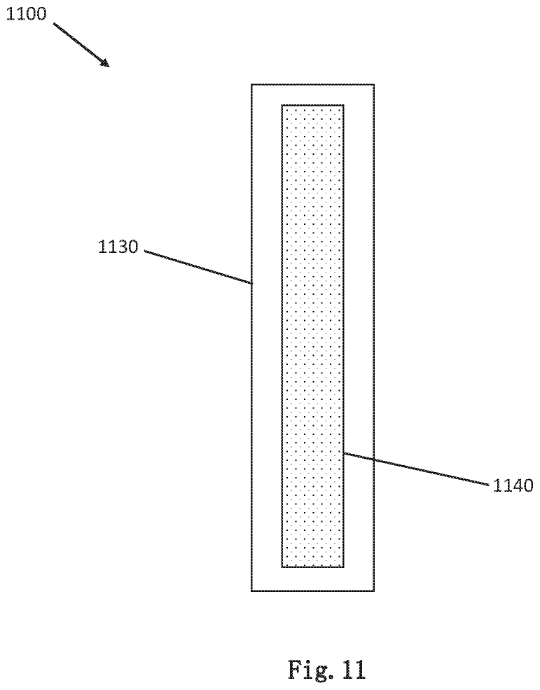

Referring to FIG. 11 there is shown a schematic representation of a filter 1100 for an air conditioning system 1130, wherein said filter includes an air treatment element 1140 of the present invention and in FIG. 9.

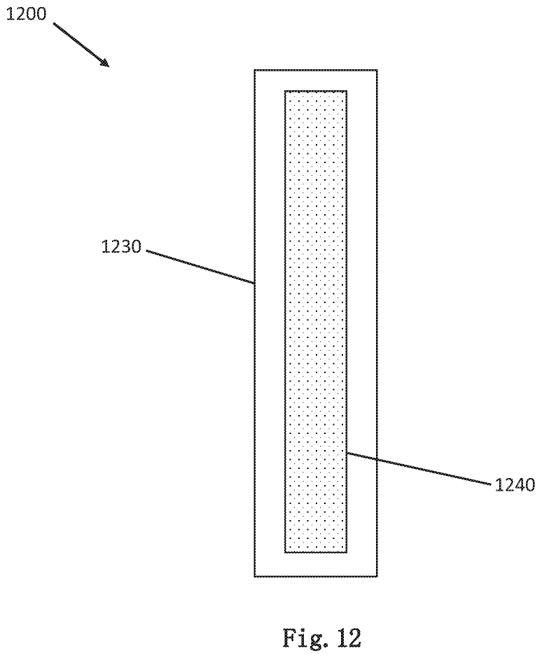

Referring to FIG. 12 there is shown a schematic representation of a filter 1200 for an air purifier 1230, wherein said filter includes an air filtration element 1240 of the present invention and in FIG. 9.

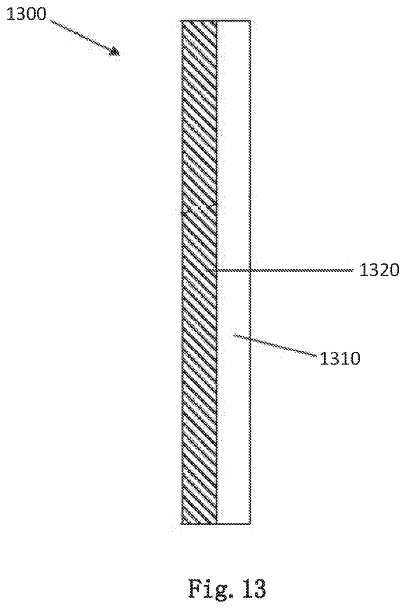

Referring now to FIGS. 13 to 16, the present invention relates to an air treatment element in order to protect a person from airborne environmental contaminants, such as bacteria and viruses.

Embodiments of the invention may be implemented in masks are often called “surgical masks” or “medical masks”.

Pure diamonds are optically transparent. Diamonds with colours are diamonds with composition impurities and crystal defects. Colour centers of diamonds are defects in the crystal structure due to structural damages from penetrating particles to kick away the carbon atoms and creating a vacancy. The vacancy can be either negatively electrostatic charged or electrostatic neutral which allows a broad range of absorption in the electromagnetic spectrum.

Nanodiamonds, characterized by a size of crystal grains less than 100 nm, have a large surface area. Combining the large surface area with the absorption capability, nanodiamonds can be used as a photochemical reaction agent or photocatalytic agent.

The present invention provides a new method to apply the physical properties of nanodiamonds, where the nanodiamonds are synthetic. The synthetic nanodiamonds can be obtained from a high-pressure-high-temperature (HPHT) process or collected from a detonation.

The physical properties being utilized is the colour centers of the nanodiamonds. The colour centers of the nanodiamonds are some defects in the crystal structure, which can be optically active defects, substitutional defects, or substitutional defects with vacancy neighbors.

The colour centers can be either negatively electrostatic charged or electrostatic neutral. The electrons in the colour centers can be optically excited to higher electronic energy states by electromagnetic waves with wavelengths within 200 nm to 900 nm and the colour centers are fluorescent under the optical excitation. After the excitation, the colour centers can be fluorescent in the electromagnetic waves with wavelengths within 300 nm to 700 nm or beyond. The synthetic nanodiamonds being used can have functional groups on their surface. The surface functional groups allow other objects to adhere and the adhesion properties can enable chances for electron transfer and nano-light source illumination.

The electron transfer and the nano-light source illumination from the nanodiamonds to the adhered object can degrade the adhered object. The electron transfer from the negatively electrostatic charged colour center occurs during the higher electronic energy state. The adhered object receives an extra electron from the negatively electrostaticcharged colour center and becomes unstable and undergoes chemical reaction and degradation. Nano-light source emitted locally by the neutral and negatively electrostatic charged colour centers irradiate and degrade the adhered object, for examples microbial and organic contaminants.

Referring now to FIG. 13, there is shown schematic representation of an air treatment element 1300 according to the present invention. The air treatment element 1300 comprises a planar air permeable substrate 1310 having a first surface, and a second surface opposed to the first surface.

A plurality of nanodiamonds 1320 bonded to at least the first surface of the air permeable substrate is provided. The nanodiamonds of the plurality of nanodiamonds includes colour centers, such that upon said colour centers being excited by light stimulus, airborne contaminants adjacent approaching the colour centers of the nanodiamonds, are denaturized.

Denaturation of airborne contaminants is a process in which proteins or nucleic acids of the contaminants lose the quaternary structure, tertiary structure, and secondary structure which is present in their native state, by application of some external stress or compound such as a strong acid or base, a concentrated inorganic salt, an organic solvent (e.g., alcohol or chloroform), radiation or heat.

If proteins in a living cell are denatured, this results in disruption of cell activity and possibly cell death. Protein denaturation is also a consequence of cell death.

Denatured proteins can exhibit a wide range of characteristics, from conformational change and loss of solubility to aggregation due to the exposure of hydrophobic groups. Denatured proteins lose their 3D structure and therefore cannot function.

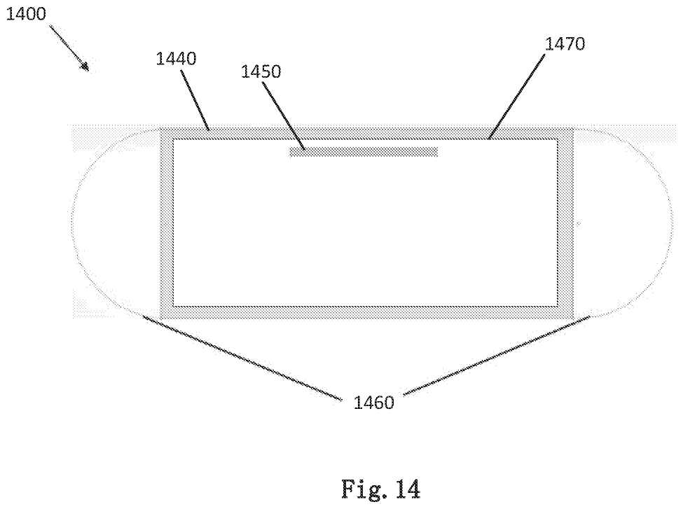

Referring to FIG. 14 there is shown a schematic representation of a surgical mask 1400, wherein said surgical mask includes an air treatment element 1470 according to the present invention and FIG. 13.

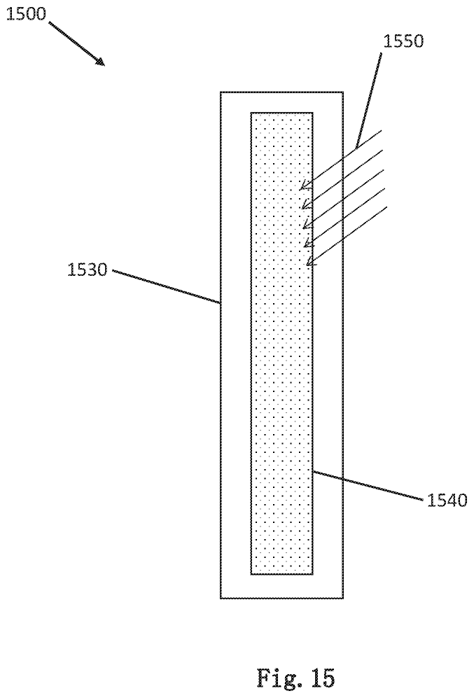

Referring to FIG. 15 there is shown a schematic representation of filter 1500 for an air conditioning system 1530, wherein said filter includes an air treatment element 1540 according to the present invention and FIG. 13. The air treatment element 1540 is being excited by light stimulus 1550.

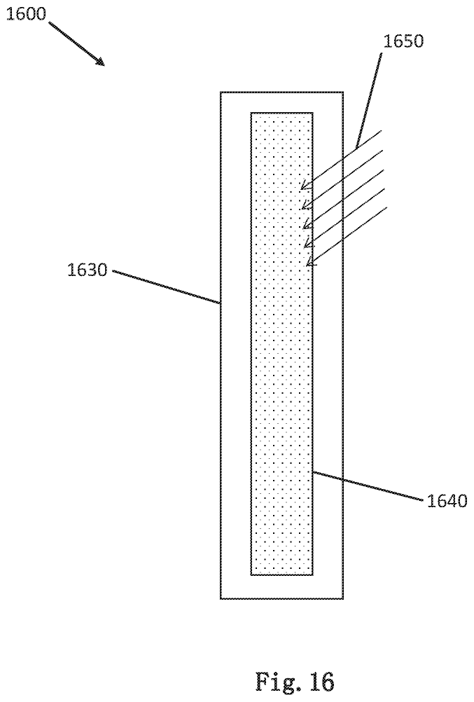

Referring to FIG. 16 there is shown a schematic representation of a filter 1600 for an air purifier 1630, wherein said filter includes an air treatment element 1640 according to the present invention and FIG. 13. The air treatment element 1640 is being excited by light stimulus 1650.

The light stimulus may be provided by ambient light, natural light, artificial light source or an LED light source by way of example.

What is claimed is:

1. A layer for a protective mask, said layer comprising:
at least a first sublayer, wherein first sublayer includes a first substrate and a layer of a plurality of nano particles of a nano material provided on said first substrate.

2. A layer for a protective mask according to claim 1, wherein said first substrate is a non-woven material.

3. A layer for a protective mask according to claim 1 or claim 2, wherein said nano material is nanodiamonds.

4. A layer for a protective mask according to any one of the preceding claims, wherein said layer further comprises a second sublayer, wherein said second sublayer includes a second substrate and a layer of an antibacterial material provided on said second substrate.

5. A layer for a protective mask according to claim 4, wherein said second substrate is a non-woven material.

6. A layer for a protective mask according to claim 4 or claim 5, wherein said antibacterial material is Chitosan.

7. A layer for a protective mask according to any one of claims 4 to 6, wherein said layer further comprises a third sublayer, wherein said third sublayer includes a layer of a metallic nanomaterial and a layer of nanocarbon material.

8. A layer for a protective mask according to claim 7, wherein said metallic nanomaterial is formed from silver nanoparticles.

9. A protective mask for removing air-borne contaminates from air inhaled by a user, wherein said mask includes a layer according to any one of claims 1 to 8.

10. A protective mask according to claim 9, wherein said protective mask comprises an outer layer, and inner layer, and wherein the layer according to any one of claims 1 to 8 is an intermediate layer disposed between said outer layer and said inner layer.

11. A protective mask according to claim 10, wherein said outer layer is formed from a non-woven hydrophobic material, and said inner layer is formed form a cotton material.

12. A protective mask for degrading germs and suppressing the penetration of germs to the human, wherein the mask includes a multilayer structure consisting of an outer layer, a middle layer, and an inner layer, wherein the outer layer is a physical block to reject the water vapor, liquids, and aerosols, and wherein the outer layer is made of an organic fibular network bonded with nanomaterials.

13. A protective mask according to claim 12, wherein said nanomaterials is non-zero band gap nanomaterials.

14. A protective mask according to claim 12, wherein said nanomaterials is wide band gap nanomaterials.

15. A protective mask according to any one of claims 12 to 14, wherein the outer layer exposed to light may emit localized light to irradiate the blocked germs.

16. A protective mask according to any one of claims 12 to 14, wherein the outer layer exposed to light may promote electron transfer to degrade the blocked germs.

17. A protective mask according to any one of claims 12 to 14, wherein the outer layer is hydrophobic due to hydrophobic surface termination of the organic fibular network.

18. A protective mask according to any one of claims 12 to 14, wherein the middle layer is a physical trap to germs.

19. A protective mask according to any one of claims 12 to 14, wherein the middle layer is a multilayer stacked organic fibular network.

20. A protective mask according to claim 19, wherein the multilayer stacked organic fibular network is made of chitosan and nano-charcoal.

21. A protective mask according to claim 19, wherein the multilayer stacked organic fibular network is bound with metallic nanomaterials.

22. A protective mask according to claim 21, wherein the middle layer exposed to light to generate localized light to irradiate the trapped germs.

23. A protective mask according to claim 21, wherein the outer layer exposed to light to promote electron transfer to degrade the blocked germs.

24. A protective mask according to any one of claims 12 to 23, wherein an intralayer fibular network spacing is reduced in the direction from the outer layer towards the inner layer in order to trap different size germs.

25. A protective mask according to any one of claims 12 to 24, wherein the inner layer is a hydrophobic for physically rejecting the water vapor, liquids, and aerosols from a user's mouth.

26. A protective mask wherein the mask includes an inner layer and an outer later, wherein the outer layer is a layer for protective mask according to claim 1.

27. A protective mask according to claim 26, wherein first substrate is a non-woven material.

28. A protective mask according to claim 26 or claim 27, wherein said nano material is nanodiamonds.

29. A protective mask according to any one of claims 26 to 28 wherein the layer of a plurality of nano particles of a nano material is the outermost layer of the mask and facing away from the inner layer.

30. An air filtration element for attenuation of airborne contaminants, said element comprising:
a planar air permeable substrate having a first surface, and a second surface opposed to said first surface; and
a plurality of nanodiamonds to bonded to said first surface of said air permeable substrate;
wherein said plurality of nanodiamonds includes negatively charged nanodiamonds, and wherein said charged nanodiamonds attenuate airborne contaminants.

31. An air filtration element according to claim 30, wherein said airborne contaminants include bacteria and viruses.

32. An air filtration element according to claim 30 or claim 31, wherein the charged nanodiamonds are bipolar, and said nanodiamonds are bonded to said first surface of said air permeable substrate by way of electrostatic charge.

33. An air filtration element according to claim 30 or claim 31, wherein the charged nanodiamonds are polar, and said nanodiamonds are bonded to said first surface of said air permeable substrate by way of a primer system.

34. An air filtration element according to any one of claims 30 to 33, wherein the air permeable substrate is formed from a synthetic fabric.

35. An air filtration element according to any one of claims 30 to 34, wherein the air permeable substrate is formed from a non-woven fabric.

36. An air filtration element according to any one of claims 30 to 35, wherein the air permeable substrate is formed from a fabric selected from the group including common non-woven fabrics, melt-blown non-woven fabrics, and electrospun microfibers or nanofibers coated non-woven fabrics.

37. An air filtration element according to any one of claims 30 to 36, wherein the air permeable substrate is formed from a non-woven fabric, wherein the material from which the non-woven fabric is formed is selected from the group including pretreated pure or a mixture of polypropylene, polyethylene, polyethylene terephthalate, polyacrylonitrile, polybutylene terephthalate, polycarbonate, polyester, polyamide, cellulose, and polyvinyl chloride.

38. An air filtration element according to any one of claims 30 to 37, wherein the air permeable substrate is formed from a mixture of natural fabrics and synthetic fabrics coated non-woven fabric.

39. An air filtration element according to any one of claims 30 to 38, wherein said plurality of nanodiamonds is deposited on the air permeable substrate by an ultrasonic spray method, an electrospinning method, or an electrostatic spray method.

40. An air filtration element according to any one of clams 30 to 39, wherein the plurality of nanodiamonds are stable in irregular shape.

41. An air filtration element according to any one of claims 30 to 40, wherein the plurality of nanodiamonds are functionalized with carboxyl or hydroxyl group.

42. An air filtration element according to any one of claims 30 to 41, further comprising a plurality of nanodiamonds bonded to said second surface of said air permeable substrate;

43. An air filtration element according to any one of claims 30 to 42, wherein the plurality of nanodiamonds is in the form of commercially available dispersion in aqueous, partially oxidized nanodiamonds, or annealed air-annealed powders.

44. An air filtration element according to any one of claims 30 to 43, wherein the plurality of nanodiamonds are hydrophilic or dual hydrophobic-hydrophilic depending on the surface functional groups.

45. A surgical mask, wherein said surgical mask includes an air filtration element according to any one of claims 30 to 44.

46. A filter for an air conditioning system, wherein said filter includes an air filtration element according to any one of claims 30 to 44.

47. A filter for an air purifier, wherein said filter includes an air filtration element according to any one of claims 30 to 44.

48. An air treatment element, said air treatment element comprises:
a planar air permeable substrate having a first surface, and a second surface opposed to said first surface;
a plurality of nanodiamonds bonded to at least said first surface of said air permeable substrate;
wherein the nanodiamonds of said plurality of nanodiamonds include colour centers, such that upon said colour centers being excited by light stimulus, airborne contaminants adjacent said colour centers of the nanodiamonds are denaturized.

49. An air treatment element according to claim 48, wherein the airborne contaminants are denaturized by electrons emitted from the excited colour centers of the nanodiamonds.

50. An air treatment element according to claim 48 or claim 49, wherein the airborne contaminants are denaturized by nano-light illuminated from the excited colour centers of the nanodiamonds.

51. An air treatment element according to any one of claims 48 to 50, wherein said airborne contaminants include bacteria and viruses.

52. An air treatment element according to any one of claims 48 to 52, wherein said nanodiamonds have functional groups on their surface, and wherein the surface functional groups provide for adhesion of said airborne contaminants to said nanodiamonds.

53. An air treatment element according to claim 52, wherein said adhesion provides for electron transfer to said airborne contaminants for denaturization thereof.

54. An air treatment element according to claim 52 or claim 53, wherein said adhesion provides for nano-light source to said airborne contaminants for denaturization thereof.

55. An air treatment element according to any one of claims 48 to 54, wherein the air permeable substrate is formed from a synthetic fabric.

56. An air treatment element according to any one of claims 48 to 55, wherein the air permeable substrate is formed from a non-woven fabric.

57. An air treatment element according to any one of claims 48 to 56, wherein the air permeable substrate is formed from a fabric selected from the group including common non-woven fabrics, melt-blown non-woven fabrics, and electrospun microfibers or nanofibers coated non-woven fabrics.

58. An air treatment element according to any one of claims 48 to 57, wherein the air permeable substrate is formed from a non-woven fabric, wherein the material from which the non-woven fabric is formed is selected from the group including pretreated pure or a mixture of polypropylene, polyethylene, polyethylene terephthalate, polyacrylonitrile, polybutylene terephthalate, polycarbonate, polyester, polyamide, cellulose, and polyvinyl chloride.

59. An air treatment element according to any one of claims 48 to 58, wherein the air permeable substrate is formed from a mixture of natural fabrics and synthetic fabrics coated non-woven fabric.

60. An air treatment element according to any one of claims 48 to 59, wherein said plurality of nanodiamonds is deposited on the air permeable substrate by an ultrasonic spray method, an electrospinning method, or an electrostatic spray method.

61. An air treatment element according to any one of claims 48 to 60, wherein the plurality of nanodiamonds are stable in irregular shape.

62. An air treatment element according to any one of claims 48 to 61, wherein the plurality of nanodiamonds are functionalized with carboxyl or hydroxyl group.

63. An air treatment element according to any one of claims 48 to 62, further comprising a plurality of nanodiamonds bonded to said second surface of said air permeable substrate;

64. An air treatment element according to any one of claims 48 to 63, wherein the plurality of nanodiamonds are in the form of commercially available dispersion in aqueous, partially oxidized nanodiamonds, or annealed air-annealed powders.

65. An air treatment element according to any one of claims 48 to 64, wherein the plurality of nanodiamonds are hydrophilic or dual hydrophobic-hydrophilic depending on the surface functional groups.

66. A surgical mask, wherein said surgical mask includes an air treatment element according to any one of claims 48 to 65.

67. A filter for an air conditioning system, wherein said filter includes an air treatment element according to any one of claims 48 to 65.

68. A filter for an air purifier, wherein said filter includes an air treatment element according to any one of claims 48 to 65.

69. An air treatment element according to any one of clams 48 to 65, wherein said light stimulus is provided by ambient light.

70. An air treatment element according to any one of claims 48 to 65, wherein said light stimulus is provided by natural light.

71. An air treatment element according to any one of claims 48 to 65, wherein said light stimulus is provided by an artificial light source.

72. An air treatment element according to claim 71, wherein said artificial light source is an LED light source.
